(19) United States
(12) Patent Application Publication
(10) Pub. No.: US 2005/0236958 A1
(43) Pub. Date: Oct. 27, 2005

(54) White light-emitting device

(75) Inventors: Bily Wang, Hsin Chu City (TW); Jonnie Chuang, Pan Chiao City (TW); Chuanfa Lin, Shu Lin City (TW); Chih Shan Yu, Chia Jen (TW)

Correspondence Address: TROXELL LAW OFFICE PLLC, SUITE 1404, 5205 LEESBURG PIKE, FALLS CHURCH, VA, 22041, US

(73) Assignee: HARVATEK CORPORATION

(21) Appl. No.: 10/830,009

(22) Filed: Apr. 23, 2004

(51) Int. Cl. H05B 33/00

(52) U.S. Cl. 313/486; 313/498; 313/485

(57) ABSTRACT

A white light source has a substrate with a blue light-emitting diode placed thereon and a phosphor mixture coated on the blue light-emitting diode and made of a red phosphor, a green phosphor and a yellow phosphor. The red phosphor can be CaS:Eu or SrS:Eu; the green phosphor can be SrGa₂S₄:Eu or Ca₈EuMnMg(SiO₄)₄C₁₂; and the yellow phosphor can be YAG:Ce or ThAG:Ce. The red phosphor, the green phosphor and the yellow phosphor emit, respectively, red light, green light and yellow light after receiving blue light from the blue light-emitting diode to mix a white light with a good color-rendering property.

### FIELD OF THE INVENTION

The present invention relates to a white light-emitting device, and especially to a white light-emitting device with both high efficiency and a good color-rendering property.

### BACKGROUND OF THE INVENTION

A white light source is generally provided by mixing light sources of different wavelengths. For example, a conventional white light source can be realized by mixing red light, green light and blue light with a suitable intensity ratio. Alternatively, the white light source can be realized by mixing yellow light and blue light with a suitable intensity ratio. The conventional method for manufacturing white light source is summarized in the following.

In a first prior art of white light source, three LED dies based on AlInGaP, InGaN and Gap are packaged into a lamp and emit red light, blue light and green light, respectively. The light emitted from the lamp can be mixed by a lens to provide white light. FIG. 1A shows a top view of a prior art white light-emitting device. The prior art white light-emitting device comprises a substrate 10, a red light-emitting diode LR, a green light-emitting diode LG and a blue light-emitting diode LB. FIG. 1B shows the emission spectrum of the prior art white light-emitting device shown in FIG. 1A. As shown in this figure, the spectrum of each light-emitting diodes is relatively narrow. However, the white light produced in this way lacks the uniform spectral distribution (especially in the 400 nm-700 nm range) of natural white light, such as sunlight. The white light thus produced has a relative chroma, which is, although indistinguishable to human eyes, differentiable to an instrument such as a camera. Therefore, the color-rendering property and reproducing ability are not satisfactory and this white light source is used mainly for lighting. Moreover, the driving voltages for LEDs of different colors are also different; this complicates the design of the driving circuit.

A second prior art of white light source was proposed by Nichia Chemical Co. in 1996, in which an InGaN based blue LED and a yellow YAG phosphor are used to provide the white light source. This white light source requires a monochrome LED to provide white light with low cost. FIG. 2 shows a top view of the second prior art white light source proposed by Nichia Chemical Co., which comprises a substrate 10, a blue light-emitting diode LB and a yellow phosphor PY coated on the blue light-emitting diode LB. The light emitted from the blue light-emitting diode LB is converted into yellow light by the yellow phosphor PY. The yellow light is mixed with the blue light to form a white light. However, the second prior art white light source proposed by Nichia Chemical Co. has a poor color-rendering property.

### SUMMARY OF THE INVENTION

It is the object of the present invention to provide a white light-emitting device with both high efficiency and a good color-rendering property.

To achieve the above object, the present invention provides a white light source including elements as follows. A blue light-emitting diode is placed on a substrate. A phosphor mixture is coated on the blue light-emitting diode and is composed of a red phosphor, a green phosphor and a yellow phosphor. The red phosphor can be CaS:Eu or SrS:Eu; the green phosphor can be SrGa₂S₄:Eu or Ca₈EuMnMg(SiO₄)₄C₁₂; and the yellow phosphor can be YAG:Ce or ThAG:Ce. The red phosphor, the green phosphor and the yellow phosphor emit, respectively, red light, green light and yellow light after receiving blue light from the blue light-emitting diode and are mixed into a white light with a good color-rendering property.

### BRIEF DESCRIPTION OF DRAWINGS

The foregoing aspects and many of the attendant advantages of this invention will be more readily appreciated as the same becomes better understood by reference to the following detailed description, when taken in conjunction with the accompanying drawings, wherein:

FIG. 1A shows a top view of a prior art white light-emitting device;

FIG. 1B shows the emission spectrum of the prior art white light-emitting device shown in FIG. 1A;

FIG. 2 shows a top view of the second prior art white light source;

FIG. 3 shows a top view of the white light source according to the first preferred embodiment;

FIG. 4A shows a top view of the white light source according to the second preferred embodiment; and

FIG. 4B shows the emission spectrum of the white light source according to the second preferred embodiment of the present invention.

### DETAILED DESCRIPTION OF THE INVENTION

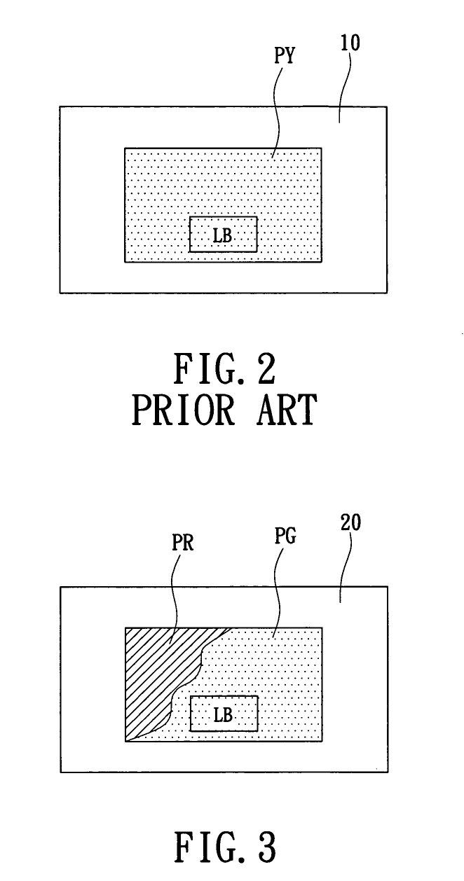

FIG. 3 shows a top view of the white light source 2 according to the first preferred embodiment. The white light source 2 according to the first preferred embodiment mainly comprises a substrate 20, a blue light-emitting diode LB on the substrate 20, red phosphor PR and green phosphor PG coated on the blue light-emitting diode LB. The red phosphor PR and green phosphor PG emit, respectively, red light and green light after receiving blue light from the blue light-emitting diode LB. The red light, green light and the blue light are mixed into a white light.

The above-mentioned red phosphor PR can be CaS:Eu or SrS:Eu; the green phosphor PG can be SrGa₂S₄:Eu or Ca₈EuMnMg(SiO₄)₄C₁₂. However, the red phosphor PR and the green phosphor PG can be other material which emits red light/green light after irradiation with light having a wavelength of 400-490 nm.

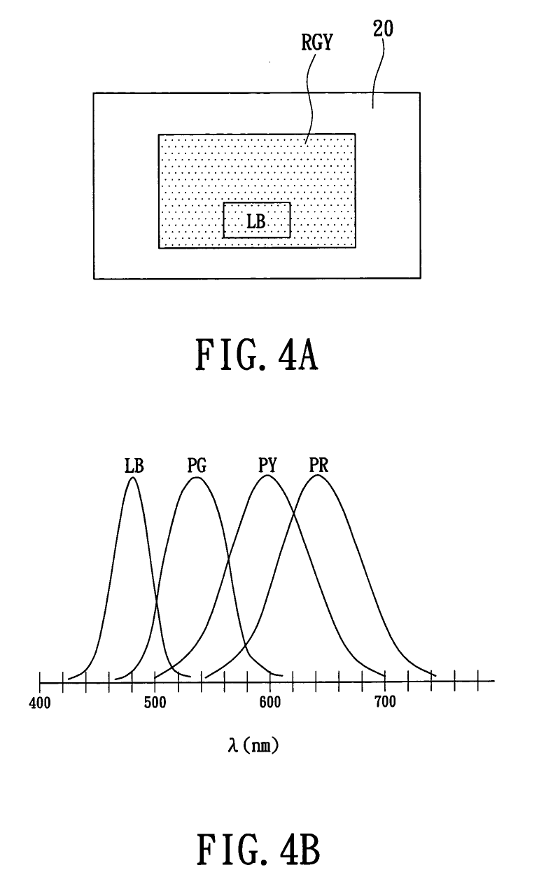

FIG. 4A shows a top view of the white light source 2 according to the second preferred embodiment. The white light source 2 according to the first preferred embodiment mainly comprises a substrate 20 such as an insulating substrate, a blue light-emitting diode LB made of nitride compound and placed on the substrate 20, and a phosphor mixture RGY coated on the blue light-emitting diode LB. The phosphor mixture RGY is the mixture of red phosphor PR, green phosphor PG and yellow phosphor PY.

The white light source 2 comprises a lead portion (not shown) for connecting the anode and cathode (not shown) to a corresponding contact on the substrate 20. The electric connection for the white light source is conventional and is not described in detail here. It should be noted that the white light source 2 could be packaged in other ways than the surface mount technology shown in this figure. For example, the white light source 2 could be packaged in lamp fashion.

The red phosphor PR, the green phosphor PG and the yellow phosphor PY emit, respectively, red light, green light and yellow light after receiving blue light from the blue light-emitting diode LB. The red light, green light, the yellow light and the blue light are mixed into a white light with good color-rendering property.

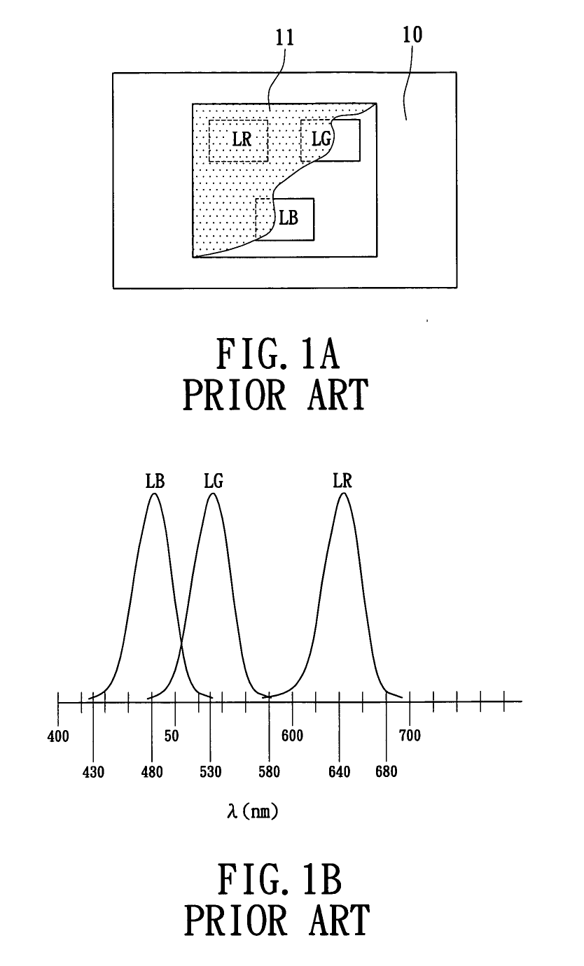

FIG. 4B shows the emission spectrum of the white light source 2 according to the second preferred embodiment of the present invention. The emission peak of the blue light-emitting diode LB, the green phosphor PG, the yellow phosphor PY and the red phosphor PR are plot from left to right. when compared with the spectrum shown in FIG. 1B, the white light source 2 according to the second preferred embodiment of the present invention has a broad spectrum contributed by the phosphors in visible light regime. Therefore, the white light source 2 according to the second preferred embodiment of the present invention has a good color-rendering property.

The added green phosphor PG and red phosphor PR can advantageously enhance the color-rendering property of the white light source 2 in comparison with the second prior art, in which only the yellow phosphor is employed. Moreover, in the present invention, the red phosphor PR, the green phosphor PG and the yellow phosphor PY can be mixed in predetermined ratio to generate a white light with different color temperature.

The above-mentioned red phosphor PR can be CaS:Eu or SrS:Eu; the green phosphor PG can be SrGa₂S₄:Eu or Ca₈EuMnMg(SiO₄)₄C₁₂; and the yellow phosphor can be YAG:Ce or TbAG:Ce. However, the red phosphor PR, the green phosphor PG and the yellow phosphor PY can be other materials, which emit red light/green/yellow light after irradiation with light having a wavelength of 400-490 nm.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A white light source, comprising:
a substrate;
a blue light-emitting diode placed on the substrate;
a phosphor mixture coated on the blue light-emitting diode and composed of a red phosphor, a green phosphor and a yellow phosphor.

2. The white light source as in claim 1, wherein the red phosphor is CaS:
Eu or SrS: Eu.

3. The white light source as in claim 1, wherein the green phosphor is SrGa₂S₄:Eu or Ca₈EuMnMg(SiO₄)₄C₁₂.

4. The white light source as in claim 1, wherein the yellow phosphor is YAG:Ce or ThAG:Ce.

5. The white light source as in claim 1, wherein the white light source is packaged in a surface mount device.

6. The white light source as in claim 1, wherein the white light source is packaged in a lamp-type device.

7. The white light source as in claim 1, wherein the substrate is an insulating substrate.

8. The white light source as in claim 1, wherein the blue light-emitting diode is made of a nitride compound.

9. The white light source as in claim 1, wherein the blue light-emitting diode emits light with a wavelength of 400-490 nm.

10. The white light source as in claim 1, wherein the red phosphor, the green phosphor and the yellow phosphor are mixed in a predetermined ratio.
